(19) United States
(12) Patent Application Publication
(10) Pub. No.: US 2023/0274165 A1
(43) Pub. Date: Aug. 31, 2023

(54) INFERENCE MODEL ON RESTRAINED GPU MEMORY

(71) Applicant: INTERNATIONAL BUSINESS MACHINES CORPORATION, ARMONK, NY (US)

(72) Inventors: Guang Han Sui, Beijing (CN); Bin Xu, Beijing (CN); Jing Li, Beijing (CN); QING XU, Beijing (CN); Lin Dong, Beijing (CN)

(21) Appl. No.: 17/652,714

(22) Filed: Feb. 28, 2022

(51) Int. Cl. G06N 5/04; G06F 9/50

(52) U.S. Cl. CPC G06N 5/04; G06F 9/5011

(57) ABSTRACT

A method, a computer program product, and a computer system run an inference model with a graphical processing unit (GPU) having a restrained resource. The method includes receiving an input to run a sequential inference process comprising a plurality of layers. The method comprises determining inference model information. The method comprises determining a count (M) of the layers for each step to load and run based on the inference model information. The method comprises determining allocations in the available GPU memory configured for data associated with the M layers, a step input and a step output, and intermediate information. The method comprises loading and running the M layers using the step input to calculate the step output. The method comprises generating the intermediate information for the step output for a subsequent step to utilize the step output as a further step input in the subsequent step.

### BACKGROUND

The exemplary embodiments relate generally to inference models, and more particularly to running an inference model with a restrained graphical processing unit.

A model may be used to in various machine learning and artificial intelligence processes in which a prediction may be generated based on a given input. The model may be trained such that the prediction is made with an increased accuracy. In performing an inference to generate the prediction, the process may utilize a graphical processing unit (GPU). The GPU may provide a previous resource for machine learning and artificial intelligence, even for a trained model. At a customer site (e.g., in a cloud architecture), the inference model for real-time requests may be held at the GPU resulting in insufficient resource availability of the GPU for other models to run.

There are numerous conventional approaches that attempt to address the scenario in which the GPU is restrained where the GPU is a limited resource. For example, a customer may be required to manually manage the inference models by unloading some inference models during an idle time and load another model for computing for real-time requests. However, such a manual approach is highly error-prone and have a significant negative impact on business operations. In another example, approaches involving mini-batch training, accumulating gradients, and gradient-checkpoints have been offered. However, these approaches are only for a training stage and cannot handle scenarios where there are insufficient GPU resources to run an inference from a trained model. That is, these approaches relate to an entirely different aspect of models (e.g., training vs. inference).

In a further example, U.S. Publ. Appln. No. 2021/0232399 provides a conventional approach to determine at least one model to process an inference request on a plurality of computing platforms, to get profile information of the at least one model, and to dynamically determine a selected computing platform. This conventional approach discloses a mechanism on how to choose a model for an inference request and how to choose the execution environment. However, this conventional approach does not provide a solution to handle the inference request in a restrained GPU environment.

In yet another example, WO 2021/022962 provides a conventional approach where a pipeline method handles the graphics rendering together with model inference. This conventional approach leverages the GPU capability which may act as both running a model inference and outputting to a display. This conventional approach may save the data move between computation and graphics rendering. However, this conventional approach does not provide a solution to handle the inference request in a restrained GPU environment.

In an additional example, U.S. Publ. Appln. No. 2021/0201438 provides a conventional approach that assumes an inference hardware (e.g., a general purpose GPU) may serve multiple inference jobs concurrently. Based on the models' characteristics (e.g., precision and data sizes), this conventional approach may allocate resources with a fine-grained policy. Accordingly, this conventional approach potentially uses fewer computing resources and saves more energy to run the same job. However, this conventional approach does not provide a solution to handle the inference request in a restrained GPU environment with a particular focus on the inference hardware's own constraints on resources where the device is incapable of loading these models concurrently.

In yet another further example, “Spatial Sharing of GPU for Autotuning DNN Models” authored by Aditya Dhakal et al. provides a conventional approach on how to auto-tune a deep neural network (DNN) model for an inference with a different fraction of resource on the same GPU device through spatial sharing with a focus on how to control the sharing schema of multiple auto-tuning process. This conventional approach requires an assumption that multiple auto-tuning processes may run in the same GPU device. However, this conventional approach does not provide a solution to handle the inference request in a restrained GPU environment.

In view of the above described conventional approaches, there is a need to provide a mechanism to build a specific environment with the restrained GPU and to load and execute the inference model with specific ways. There is also a need for the inference model to be executed in a GPU when the GPU's available resources is incapable of loading the whole inference model. There is a further need for multiple models for inference are loaded concurrently in parallel on a GPU with constraints on resources (e.g., memory).

### SUMMARY

The exemplary embodiments disclose a method, a computer program product, and a computer system for running an inference model with a graphical processing unit (GPU) having a restrained resource. The method comprises receiving an input for which the inference model is run using a sequential inference process comprising a plurality of steps. The inference model comprises a plurality of layers including a first layer representing the input, a last layer representing an output for the input as generated by running the inference model, and at least one intermediate layer between the first layer and the last layer. The method comprises determining information associated with the inference model including an input size for each of the layers, an output size for each of the layers, and an available GPU memory on which the inference model is to run. The available GPU memory is the restrained resource. The method comprises determining a count (M) of the layers based on the information associated with the inference model. The count is a value less than a total number of the layers of the inference model. Each of the steps of the sequential inference process load and run M layers of the layers of the inference model. The method comprises determining allocations in the available GPU memory for each of the steps of the sequential inference process. The allocations are configured for data associated with the M layers, a step input and a step output, and intermediate information. The step input is input data for one of the steps. The step output is output data for the one of the steps. The intermediate information is memory identification information for the step output. The method comprises loading and running the M layers using the step input to calculate the step output. The method comprises generating the intermediate information for the step output for a subsequent step to utilize the step output as a further step input in the subsequent step.

In a preferred embodiment, as a result of calculating the step output for the M layers, the method further comprises releasing one of the M layers and further loading and further running a further one of the layers of the inference model to create further M layers for the subsequent step.

In a preferred embodiment, the released one of the M layers is a lowest level layer among the M layers and the loaded one of the further M layers is a next higher level layer relative to the M layers.

In a preferred embodiment, the method further comprises repeating the loading and running step, the generating step, the releasing step, and the further loading and further running step until the further M layers includes a last layer of the layers of the inference model.

In a preferred embodiment, the memory identification information indicates a location within the allocations where the step output is stored.

In a preferred embodiment, the step input for a first step of the sequential inference process corresponds to the input and the step output for a last step of the sequential inference process corresponds to the output.

In a preferred embodiment, the step output is retained in the allocations until a last layer of the layers of the inference model is processed.

### BRIEF DESCRIPTION OF THE SEVERAL VIEWS OF THE DRAWINGS

The following detailed description, given by way of example and not intended to limit the exemplary embodiments solely thereto, will best be appreciated in conjunction with the accompanying drawings, in which:

FIG. 1 depicts an exemplary schematic diagram of a model prediction system 100, in accordance with the exemplary embodiments.

FIG. 2 depicts an exemplary flowchart of a method 200 illustrating the operations of an inference program 114 incorporated in the edge device 110 of the model prediction system 100 in running an inference model with a restrained graphical processing unit (GPU), in accordance with the exemplary embodiments.

FIG. 3 depicts an exemplary representation of allocations in a restrained GPU, in accordance with the exemplary embodiments.

FIG. 4 depicts an exemplary full inference, in accordance with the exemplary embodiments.

FIG. 5 depicts an exemplary series of sequences for the full inference of FIG. 4, in accordance with the exemplary embodiments.

FIG. 6 depicts an exemplary block diagram depicting the hardware components of the model prediction system 100 of FIG. 1, in accordance with the exemplary embodiments.

FIG. 7 depicts a cloud computing environment, in accordance with the exemplary embodiments.

FIG. 8 depicts abstraction model layers, in accordance with the exemplary embodiments.

The drawings are not necessarily to scale. The drawings are merely schematic representations, not intended to portray specific parameters of the exemplary embodiments. The drawings are intended to depict only typical exemplary embodiments. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

The exemplary embodiments are directed to a method, computer program product, and system for running an inference model with a restrained graphical processing unit (GPU). The exemplary embodiments provide a mechanism that utilizes characteristics of the inference model including a total number of layers to determine a subset of the layers that may be used to run the inference model for steps of a sequential inference process. In this manner, the exemplary embodiments may allocate available resources of the GPU to run the inference model. The mechanism according to the exemplary embodiments load and off-load partitions of the inference model via its layers sequentially to reduce a model loading latency and improve resource usage. Key benefits of the exemplary embodiments may include enable concurrent models to run on the GPU, maximizing the efficiency of the GPU by using available resources to run an inference model despite the available resources being incapable of loading the entire inference model, allowing the inference model to still be completed despite the GPU being restrained and incapable of loading the entire inference model, enabling the inference model to run on the GPU with a specified memory size or other specified condition to control use of the GPU for the inference, and providing an improved performance over loading all layers of an inference into the GPU to calculate. Detailed implementation of the exemplary embodiments follows.

The exemplary embodiments are described with particular reference to inference models and using the GPU in running the inference models. However, the use of inference models and the GPU are only exemplary. The exemplary embodiments may be utilized in any environment in which a unit requires resources on a processing device where the unit may be divided into sub-components and processed sequentially, resulting in the unit being run as a whole on the processing device to generate the output.

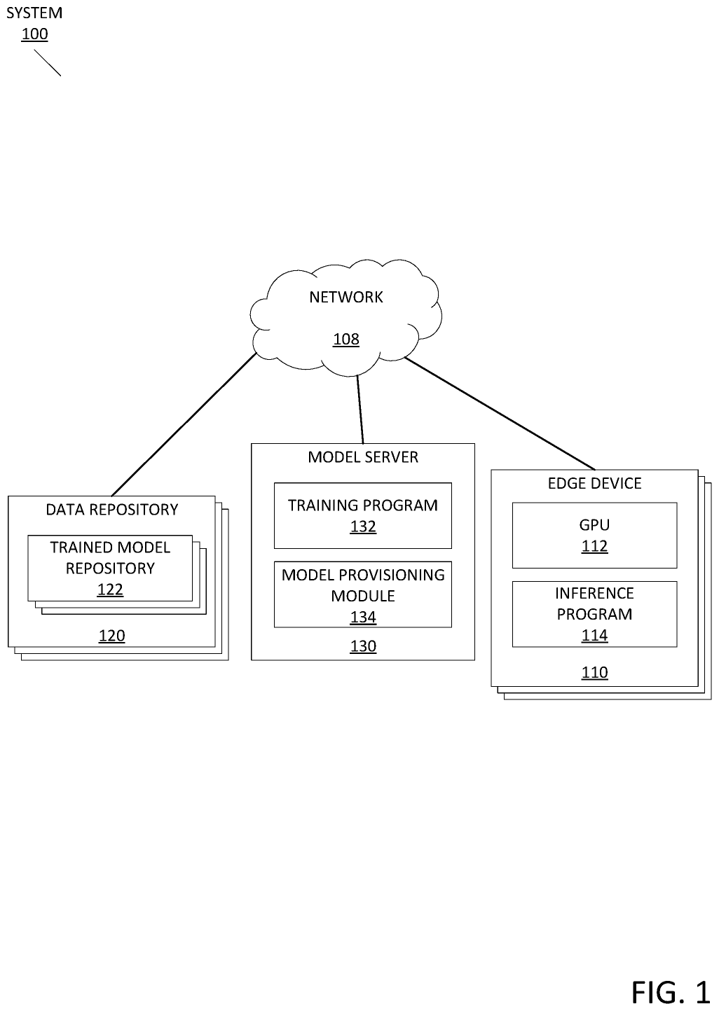

FIG. 1 depicts a model prediction system 100, in accordance with the exemplary embodiments. According to the exemplary embodiments, the model prediction system 100 may include an edge device 110, one or more data repositories 120, and a model server 130, which may all be interconnected via a network 108. While programming and data of the exemplary embodiments may be stored and accessed remotely across several servers via the network 108, programming and data of the exemplary embodiments may alternatively or additionally be stored locally on as few as one physical computing device or amongst other computing devices than those depicted.

In the exemplary embodiments, the network 108 may be a communication channel capable of transferring data between connected devices. Accordingly, the components of the model prediction system 100 may represent network components or network devices interconnected via the network 108. In the exemplary embodiments, the network 108 may be the Internet, representing a worldwide collection of networks and gateways to support communications between devices connected to the Internet. Moreover, the network 108 may utilize various types of connections such as wired, wireless, fiber optic, etc. which may be implemented as an intranet network, a local area network (LAN), a wide area network (WAN), or a combination thereof. In further embodiments, the network 108 may be a Bluetooth network, a WiFi network, or a combination thereof. In yet further embodiments, the network 108 may be a telecommunications network used to facilitate telephone calls between two or more parties comprising a landline network, a wireless network, a closed network, a satellite network, or a combination thereof. In general, the network 108 may represent any combination of connections and protocols that will support communications between connected devices. For example, the network 108 may also represent direct or indirect wired or wireless connections between the components of the model prediction system 100 that do not utilize the network 108.

The model prediction system 100 and the network 108 may also be representative of a plurality of different data exchange environments. For example, the components of the model prediction system 100 may be part of a cloud network and the network 108 may provide the corresponding network connections among the components of the model prediction system 100 for data exchanges to be performed over the cloud along with cloud services being provided to customers (e.g., users of the edge device 110).

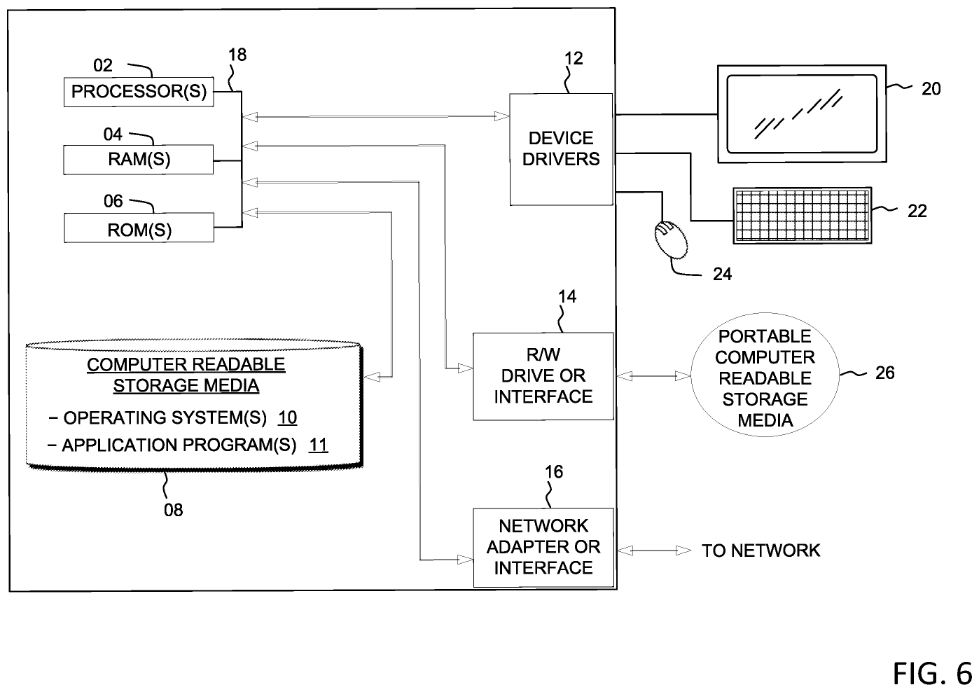

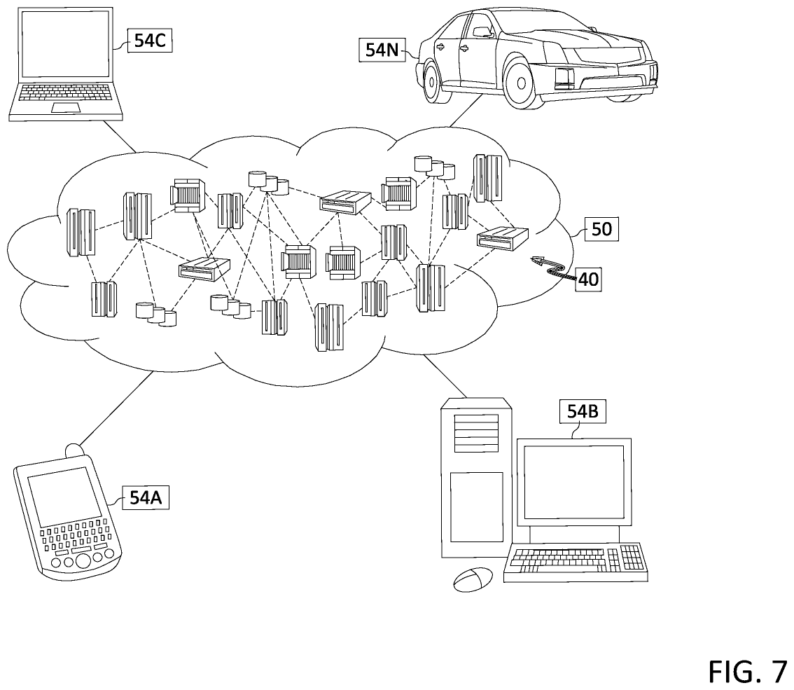

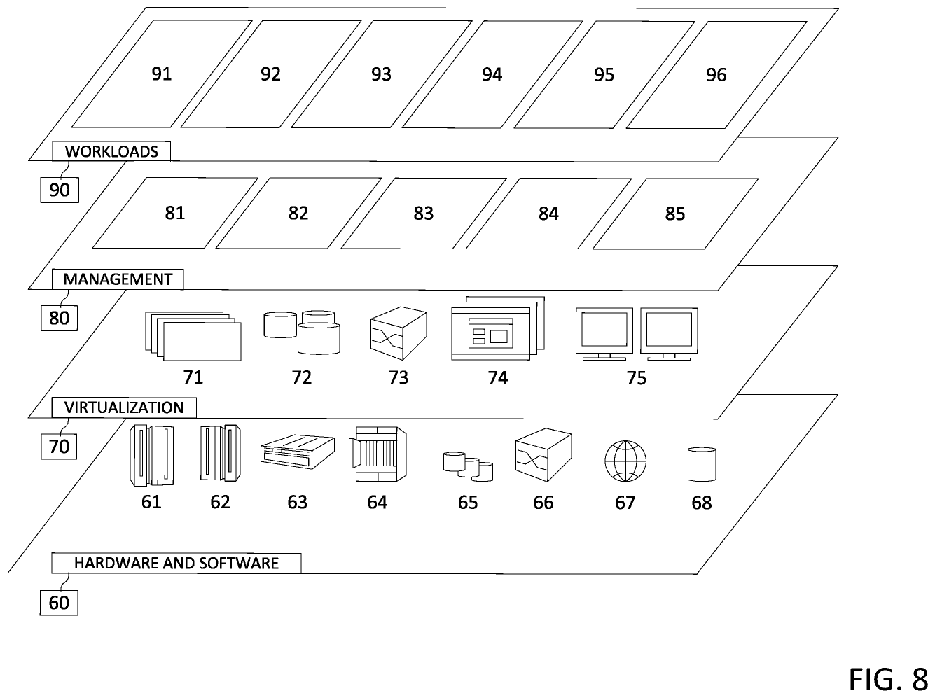

In the exemplary embodiments, the edge device 110 may include a GPU 112 and an inference program 114, and may be an enterprise server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, an Internet of Things (IoT) device, or any other electronic device or computing system capable of receiving and sending data to and from other computing devices. While the edge device 110 is shown as a single device, in other embodiments, the edge device 110 may be comprised of a cluster or plurality of computing devices, in a modular manner, etc., working together or working independently. The edge device 110 is described in greater detail as a hardware implementation with reference to FIG. 6 (e.g., data processing according to the exemplary embodiments being performed by processor 02), as part of a cloud implementation with reference to FIG. 7 (e.g., the device 110 according to the exemplary embodiments being represented by the laptop computer 54C), and/or as utilizing functional abstraction layers for processing with reference to FIG. 8 (e.g., workload layer 90 including inference model processing 96 according to the exemplary embodiments).

In the exemplary embodiments, the GPU 112 may be any processing device that may include a specialized electronic circuit configured to utilize memory to accelerate a creation of an image in a frame buffer to be shown on a display device. The GPU 112 may be described as having a GPU memory (e.g., a portion of a memory arrangement of the edge device 110 allocated to the GPU 112). In this manner, the GPU memory may be a resource that is available to the GPU 112. According to an exemplary implementation in which the exemplary embodiments may be utilized, the GPU 112 may be in a restrained state where the available resources are restrained (i.e., restrained resources). Accordingly, the GPU 112 in the restrained state may be referred to as a restrained GPU or a restrained GPU memory (e.g., when specifically referring to the restrained resource being the memory allocated to the GPU 112).

As those skilled in the art will understand, the GPU 112 may be of substantial importance in artificial intelligence and machine learning systems. For example, the GPU 112 and the GPU memory may be a precious resource for such systems when performing an inference and generating a prediction for an input utilizing a trained model. The GPU 112 may be highly efficient at manipulating computer graphics and performing image processing, which may be involved in performing the inference. For example, the GPU 112 may utilize a parallel structure to provide this efficient mechanism such that large blocks of data may be processed in parallel.

In the exemplary embodiments, the inference program 114 may act as a client in a client-server relationship and may be a software, hardware, and/or firmware based application performing an inference using an inference model utilizing the features of the exemplary embodiments and exchange data via the network 108. In embodiments, the inference program 114 may provide a user interface allowing the user of the edge device 110 to provide one or more inputs to generate a prediction (e.g., that may be output and shown on a display device) and interact with one or more components of the communication transfer system 100, and utilize various wired and/or wireless connection protocols for data transmission and exchange associated with establishing and performing a communication session, including Bluetooth, 2.4 gHz and 5 gHz internet, near-field communication, Z-Wave, Zigbee, etc.

The inference program 114 may be configured to run an inference model on the GPU 112 having a restrained resource (e.g., a restrained GPU). According to the exemplary embodiments, the inference program 114 may run the inference model represented as a set of layers by processing a portion of the layers of the inference model sequentially until the set of layers has been processed to generate a prediction for an input of the inference model. As will be described in further detail below, the inference program 114 may perform operations including determining and/or collecting information of the inference model to be used and the available GPU memory of the restrained GPU for the inference model, determining a number or count (M) of layers that may be repeated to finish the inference model and generate the prediction/result/output for a given input, allocating the available GPU resource or GPU memory configured for the M layers, a step input and a step output for a given step of the sequential inference process, and intermediate information for the given step of the sequential inference process to be used by a subsequent step of the sequential inference process, loading the input and the M layers into allocated portions of the GPU memory and updating the intermediate information, and repeating these operations by releasing a processed layer and loading a further layer such that the steps of the sequential inference process is performed on all the layers of the inference model until the output is generated (e.g., the last layer is processed).

As noted above, the inference model according to the exemplary embodiments may utilize a sequential inference process including a plurality of steps in the sequence. For the overall inference model, there may be an input (e.g., as provided by a user) for which the inference model is run to generate an output that may be a prediction based on the inference model. For each step of the sequential inference process, there may be a step input and a step output. That is, for a given step, the step input and the step output are specific to that step. As one skilled in the art will understand, the step input of the first step may correspond to the input of the inference model while the step output of the last step may correspond to the output of the inference model.

In the exemplary embodiments, the data repository 120 may include one or more trained model repositories 122 and may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of storing, receiving, and sending data to and from other computing devices. While the data repository 120 is shown as a single device, in other embodiments, the data repository 120 may be comprised of a cluster or plurality of electronic devices, in a modular manner, etc., working together or working independently. While the data repository 120 is also shown as a separate component, in other embodiments, the data repository 120 may be incorporated with one or more of the other components of the model prediction system 100. For example, the data repository 120 may be incorporated in the model server 130. Thus, access to the data repository 120 by components of the model server 130 may be performed locally. The data repository 120 is described in greater detail as a hardware implementation with reference to FIG. 6, as part of a cloud implementation with reference to FIG. 7, and/or as utilizing functional abstraction layers for processing with reference to FIG. 8.

In the exemplary embodiments, the trained model repository 122 may include one or more trained models. The model prediction system 100 may be configured to prepare trained models to be used for inferences. The trained models may be used for a variety of purposes having corresponding inference purposes.

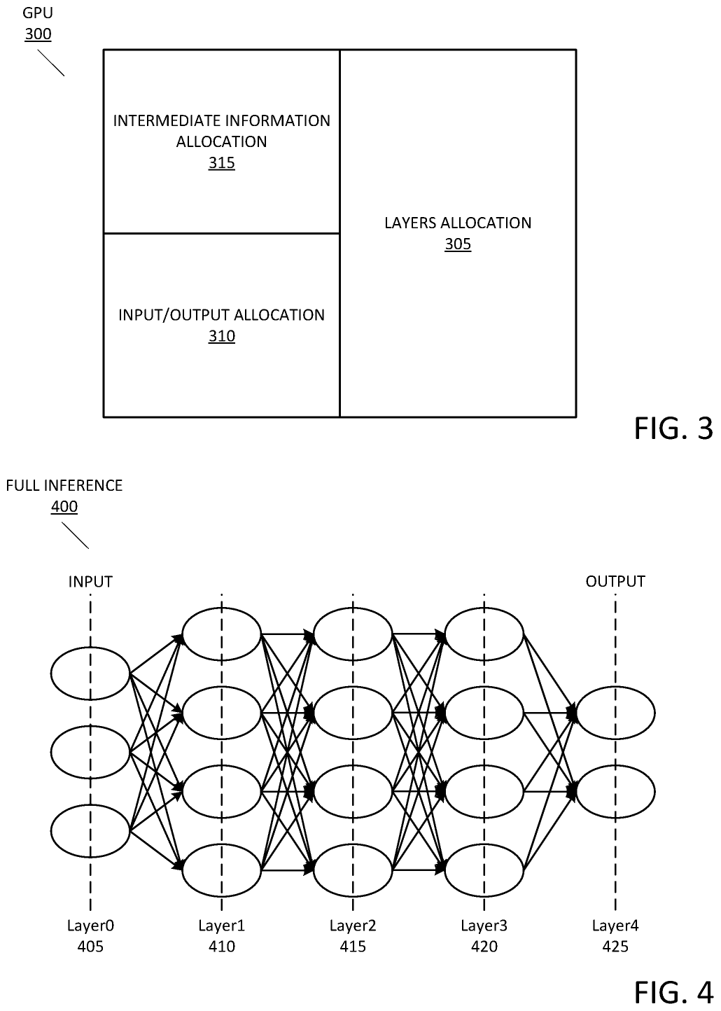

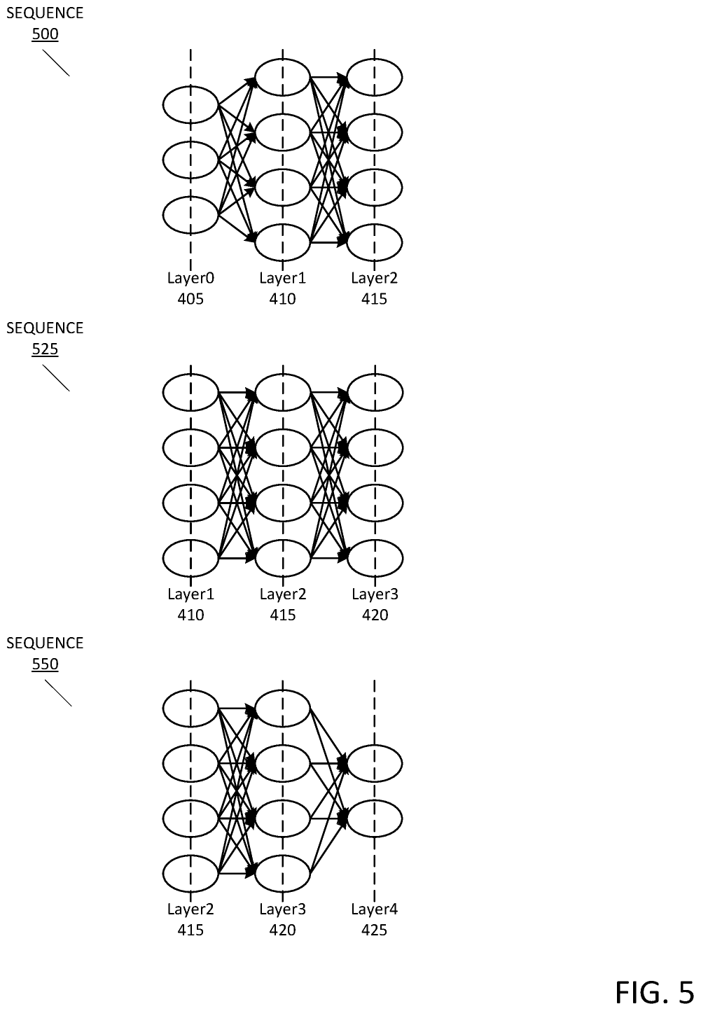

In the exemplary embodiments, the model server 130 may include a training program 132 and a model provisioning program 134, and act as a server in a client-server relationship with the inference program 114 of the edge device 110 as well as be in a communicative relationship with the data repository 120. The model server 130 may be an enterprise server, a laptop computer, a notebook, a tablet computer, a netbook computer, a PC, a desktop computer, a server, a PDA, a rotary phone, a touchtone phone, a smart phone, a mobile phone, a virtual device, a thin client, an IoT device, or any other electronic device or computing system capable of receiving and sending data to and from other computing devices. While the model server 130 is shown as a single device, in other embodiments, the model server 130 may be comprised of a cluster or plurality of computing devices, working together or working independently. The model server 130 is described in greater detail as a hardware implementation with reference to FIG. 3 (e.g., data processing according to the exemplary embodiments being performed by processor 02), as part of a cloud implementation with reference to FIG. 4 (e.g., the device 110 according to the exemplary embodiments being represented by the desktop computer 54B), and/or as utilizing functional abstraction layers for processing with reference to FIG. 5 (e.g., workload layer 90 including retroactive processing 96 according to the exemplary embodiments).

In the exemplary embodiments, the training program 132 may be a software, hardware, and/or firmware application configured to generate the trained models stored in the trained model repository 122. The training program 132 may perform the training utilizing various techniques, any of which may be incorporated by the exemplary embodiments (e.g., RNNs, CNNs, DNNs, etc.). As one skilled in the art will understand, the training program 132 may be associated with one aspect of models in which a machine learning algorithm is created (i.e., the inference model). The training program 132 may utilize a deep-learning framework and one or more training datasets to train the model. The trained model may subsequently be used in an inference operation. Accordingly, the inference may be associated with another aspect of models in which the trained model is used to generate a prediction for an input.

In the exemplary embodiments, the model provisioning program 134 may be a software, hardware, and/or firmware application configured to provide the trained model stored in the trained model repository 122 to inference program 114 of the edge device 110. The edge device 110 may request the trained model to be used in the inference model at a variety of times. For example, when an input is received and an objective in running an inference is identified, the inference program 114 may request the appropriate trained model to be used as the inference model. In another example, the inference program 114 may have a plurality of trained models prepared for use based on an objective to be achieved at the edge device 110. Accordingly, based on the various objectives, the model provisioning program 134 may provide the trained models aligned with the intended objectives of the edge device 110 (e.g., image analysis for identification purposes).

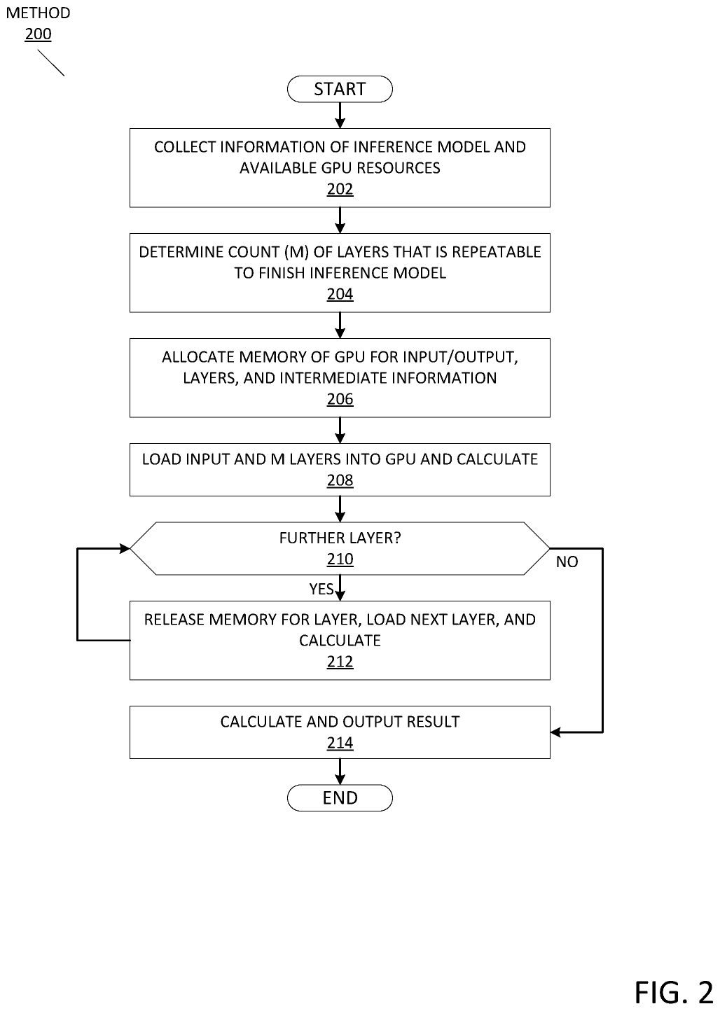

FIG. 2 depicts an exemplary flowchart of a method 200 illustrating the operations of an inference program 114 incorporated in the edge device 110 of the model prediction system 100 in running an inference model with the GPU 112 that is in a restrained state, in accordance with the exemplary embodiments. The method 200 may relate to operations that are performed by the inference program 114 with a trained model (e.g., stored in the trained model repository 122 of the data repository 120) provided by the model provisioning program 134 of the model server 130. The method 200 will be described from the perspective of the inference program 114.

The method 200 may be performed with a plurality of assumptions in place. For example, the method 200 may assume that the edge device 110 already has or has access to the appropriate trained model to be used as the inference model in performing an inference at the edge device 110 (e.g., as provided by the model provisioning program 134). In another example, the method 200 may assume that the GPU 112 may be in the restrained state such as a restrained GPU memory. Accordingly, the available memory of the GPU 112 for running the inference model may be incapable of running the entire inference model at a given time. If the GPU 112 is in an unrestrained state or the entire inference model may be run in the available GPU memory at a given time, the edge device 110 may utilize any mechanism in performing the inference and generating a prediction or output for a given input. In a further example, the method 200 may assume that the conditions of the GPU 112 may remain substantially constant throughout the inference program 114 performing the operations of the exemplary embodiments. However, the method 200 may also be configured in a dynamic manner with a condition update operation and dynamic process selection. For example, the method 200 may incorporate the condition update operation that may continuously determine (e.g., throughout the process, at predetermined intervals, at the occurrence of an event, etc.) an amount of an available resource the GPU 112 (e.g., the available GPU memory). Based on a result of this process, the method 200 may modify the process. Alternative processes that may be used in this dynamic manner will be described in further detail below.

The inference program 114 may determine or collect information of the inference model and available GPU resources of the GPU 112 (step 202). The inference program 114 may determine or collect a variety of different types of information of the inference model that is to be used in performing the inference for a given input. Initially, the inference program 114 may receive an input for which the inference is to be performed. The inference program 114 may be configured to determine the trained model to be used as the inference model. In another example, the user may directly or indirectly identify the objective for which the inference is to be performed while providing the input. Using this information, the inference program 114 may determine information such as an input size, an output size of each layer, a total count (N) of layers of the inference model, nodes in each layer including the initial input layer (e.g., layer0) and the final output layer (e.g., layerN), etc. As a separate or independent determination, the inference program 114 may also determine the available GPU resource to perform this particular inference and run/load the inference model. For illustrative purposes, the GPU resource will be described in reference to the GPU memory available to the GPU 112 to run the inference model although other GPU resources may also be considered such as GPU processing power. For example, based on operations running at a time that the inference is to be performed (e.g., other inferences, standard GPU operations for image processing, etc.), the inference program 114 may determine a remaining portion of the GPU memory that remains available.

The inference program 114 may determine a count, M, of layers that is repeatable to finish or complete the inference model (step 204). As described above, the exemplary embodiments are configured to load and run a subset of the N layers involved in performing the inference associated with the inference model for a given input. The M layers that are to be run as a subset of the N total layers of the inference model may be based on the available GPU memory. According to the exemplary embodiments, the inference program 114 may determine the count M based on a variety of factors. In an exemplary implementation, the inference program 114 may determine the count M of the layers to be used in a sequential inference process based on a size of the M layers, the step input and the step output for a given layer, and a size of intermediate information for the given layer. As these variables comprise the various types of information to be stored for a step in the sequential inference process, the inference program 114 may utilize this information in determining the count M based on the available GPU memory. For example, the inference program may utilize the following formula:

max(size for M layers that load together)+2*max(step input,max(step output of a layer))+(size of intermediate information)=available GPU memory for inference

To illustrate the above determination, in an exemplary embodiment, the inference model may have five total layers (e.g., layer0 to layer4, where layer0 represents the input layer, layer4 represents the output layer, and layer1, layer2, layer3 represent intermediate “hidden” layers) and the number of M layers may define the sequential inference process. For example, based on the size of the intermediate information, the step input, and the step output, as a result of the count M being two, the sequence of loading the layers may be layer0+layer1, layer1+layer2, layer2+layer3, layer3+layer4. In another example, based on the size of the intermediate information, the input, and the output, as a result of the count M being three, the sequence of loading the layers may be layer0+layer1+layer2, layer1+layer2+layer3, layer2+layer3+layer4.

The M layers to be loaded being based on the available GPU memory also allows the exemplary embodiments to provide manually selectable aspects. For example, the inference model may be run on the GPU 112 with a user specified memory size. That is, the user may specify the available GPU memory allocated for the inference. In this manner, the user may retain control of how much of the GPU memory is to be used for all other purposes. In another example, the user may also select the count M of the layers to be used in each step of the sequential inference process. Accordingly, in one exemplary implementation, the inference program 114 may be configured to determine the count M while in another exemplary implementation, the user may specify the maximum number of layers M that is allowed to be loaded for a given step of the sequential inference process. The inference program 114 may verify whether the user specified value of the count M. For scenarios where the available GPU memory and the other parameters define otherwise, the inference program 114 may provide an indication to the user that a different count M is to be input. The inference program 114 may be configured to provide a suggestion for the count M. The inference program 114 may also be configured to override the user's selection, particularly when the user selected value is not viable.

As noted by the variables in the above described manner of determining the count M, the mechanism according to the exemplary embodiments in performing an inference by running an inference model through a sequential inference process where a subset of M layers among the N total layers is used at a given time involves only loading this subset of M layers into the GPU memory rather than the total N layers. Subsequently, once this subset of M layers is processed, the mechanism according to the exemplary embodiments may release a processed one or more of the M layers so that further layers are loaded and processed in the sequence. Each step of the sequential inference process may thereby load and run M layers. In this manner, a maximum GPU memory size for the loaded layers may be observed.

In addition to the layers that are to be loaded, a portion of the GPU memory may be required for the step input as well as the step output. For a given step of the sequential inference process, the step may include a step input and a step output. For example, the first step of the sequential inference process may include the step input as the initial input (e.g., as provided by the user for the inference to be performed) represented as layer0. The first step may also perform a calculation to generate the step output which serves as the step input to the next step of the sequential inference process. The intermediate one or more steps of the sequential inference process (e.g., the steps between the first and last steps) may utilize the step output from a prior step (e.g., an immediately prior step) and generate a step output to be used in a subsequent step (e.g., an immediately subsequent step). The sequential inference process may continue in this manner until the last step of the sequential inference process may include a step output from the previous step of the sequential inference process (e.g., in processing layerN−1) that serves as the step input of the last step such that a calculation is performed to generate the output (e.g., the prediction for the initial input for which the inference is performed) represented as layerN. Accordingly, as indicated above, the portion of the manner of determining the count M is represented as a combination of the input and the output for the step of the sequential inference process.

In addition to the layers that are to be loaded, the step input, and the step output, a portion of the GPU memory may be required for intermediate information that is generated such that the sequential inference process may be performed seamlessly. For a given step of the sequential inference process, the step may therefore include the intermediate information. The intermediate information may be used to record a location of a step output from a previous layer, so that the subsequent layer may read the step output from this previous layer to be used as the step input in the current layer. The intermediate information may include any other information that may be used so that the sequential inference process may be performed seamlessly between layers (e.g., adjacent layers) such as preventing redundant processing or calculating when applicable. The actual size of the intermediate information is a variable that is dependent on the algorithm that is being used in the inference. For example, for general inferences, the size of the intermediate information identifying a location of the output from a previous layer may only utilize several bytes.

The inference program 114 may allocate the available GPU memory of the GPU 112 for the input/output, for the M layers in each step of the sequential inference process, and for the intermediate information (step 206). The inference program 114 may determine a manner in which to divide the available GPU memory such that the appropriate data is properly loaded and stored.

FIG. 3 depicts an exemplary representation of allocations 305, 310, 315 in a GPU 300 that is in a restrained state, in accordance with the exemplary embodiments. The GPU 300 may represent the available GPU of the GPU 112. As such, the GPU 300 may be a portion of the GPU 112 that is available for the inference model while the GPU 112 is in the restrained state. As illustrated, the inference program 114 may divide the GPU 300 into the layers allocation 305, the input/output allocation 310, and the intermediate information allocation 315. As described above, each of the allocations 305, 310, 315 may be determined based on a size of the GPU 300 (e.g., using the formulation described above). In this manner, the inference program 114 may set aside predetermined and/or dynamically determined portions of the GPU 300 which are then allocated to the appropriate types of data. For example, the M layers for a given step of the sequential inference process may be stored/loaded into the layers allocation 305; the input for the step of the sequential inference process may be stored in the input/output allocation 310; the resulting output from the step of the sequential inference process may be stored in the input/output allocation 310; and the intermediate information to be used by the subsequent step in the sequential inference process may be generated and stored in the intermediate information allocation 315. The input/output allocation 310 being represented as a unitary allocation is only exemplary. The inference program 114 may determine an input allocation and a separate output allocation. The allocations 305, 310, 315 shown in the GPU 300 are only representative of what the GPU 300 may comprise and are not shown to scale.

Once the appropriate determinations and preparations have been made, the inference program 114 may load the step input and M layers into the appropriate allocated portions of the available GPU memory and perform a calculation with this load (step 208). The processing of the layers of the inference model may be performed using various techniques, any of which may be incorporated by the exemplary embodiments. For example, the layers that are loaded may be handled one at a time in the order that the layers are loaded according to the inference model. For the layers that are loaded, the inference program 114 may be configured for each layer to read the previous layer's step output and calculate its step output and save. In the exemplary embodiments, in view of the restrained state of the GPU 112 and only utilizing the available GPU memory, the inference program 114 may generate the intermediate information that is updated to save the current layer's step output position in the available GPU memory (e.g., a location in the input/output allocation 310).

The inference program 114 may determine whether there is a further layer to be processed for the inference model (decision 210). As described above, the exemplary embodiments perform the sequential inference process in which M layers comprising a subset of the N total layers is loaded. Accordingly, there may be one or more further layers to be processed until the last layer is processed (e.g., layerN) so that the prediction for the inference is generated. Thus, if there is at least one further layer to be processed, the inference model is incomplete and requires loading the remaining at least one further layer to be processed.

As a result of the inference program 114 determining that there is at least one further layer (decision 210, “YES” branch), the inference program 114 may release the portion of the GPU memory used in processing a given layer, load the next layer, and perform another calculation with this new load (step 212). According to an exemplary implementation, the inference program 114 may release one layer at a time and add another one layer for the next step of the sequential inference process. In a particular manner of this exemplary implementation, the inference program 114 may release the lowest level layer that is loaded in the M layers and load the next higher level layer. For example, with M being three, in a step of the sequential inference process, the inference program 114 may have loaded M layers as layerX, layerX+1, and layerX+2. Once run and processed, the inference program 114 may generate an output for the M layers currently loaded (e.g., that is stored in the input/output allocation 310) and generate the intermediate information (e.g., that is stored in the intermediate information allocation 315) indicating a location for this output in the input/output allocation 310. Subsequently, the inference program 114 may release layerX and proceed to the next step of the sequential inference program by loading layerX+3 such that the M layers that are loaded are layerX+1, layerX+2, and layerX+3. This process may continue until the M layers that are loaded includes the layerN or the final layer of the inference model where the output of the layerN is the prediction for the input of the inference. In this manner, the inference program 114 may perform calculations continuously and sequentially, with the layers remaining in the M layers between steps of the sequential inference process being calculated parallelly.

The inference program 114 may continue this process until the last layer (e.g., layerN) is reached. As a result of the inference program 114 determining that there is no further layer (decision 210, “NO” branch), the inference program 114 may perform a further calculation and generate the output for the input (e.g., where the step output of the last layer corresponds to the output) such as generating a prediction (step 214). In this manner, the inference program 114 may perform the entire inference and process the entire inference model in this sequential manner.

The inference program 114 may manage the data in the available GPU to ensure that the sequential inference process is performed properly and seamlessly. For example, the inference program 114 may store the intermediate information for as long as the specific intermediate information for a given step of the sequential inference process is needed. Alternatively, the inference program 114 may continue to store the intermediate information for each step until the inference model is completed. As noted above, in view of the relatively small size that the intermediate information may require, the storage of the intermediate information may not create a burden despite the GPU 112 being in a restrained state with only the available GPU memory being allocated for the inference. In another example, the inference program 114 may retain the output from each layer until the last layer is processed. By storing the output of each layer, the inference program 114 may minimize costs of copying data.

As noted above, the method 200 may be modified for a variety of reasons. For example, as described above, the inference program 114 may load M layers, process these M layers, and then release a lowest level layer and load a next higher level layer. That is, according to this exemplary implementation, the inference program 114 may release and load layers one at a time for each step of the sequential inference process. However, if the GPU 112 is configured properly and the inference program 114 determines that the inference model may be properly handled, the inference program 114 may release and load M-Y layers for each step, where Y is a value less than M. In this manner, at least one layer remains in the M layers between steps of the sequential inference process that is calculated parallelly. In another example, the inference program 114 may perform various determinations such that the method 200 is performed dynamically based on the changing conditions of the GPU 112 and the available GPU memory. For example, if the GPU 112 enters an unrestrained state, the inference program 114 may revert to an approach where the entire inference model (e.g., all the layers) is loaded and run to generate the prediction for the input. In a dynamic approach, the inference program 114 may have already processed at least one step of the sequential inference process. At some time prior to the last step of the sequential inference process, the inference program 114 may have determined that the GPU 112 enters an unrestrained state. The inference program 114 may still rely on the features of the exemplary embodiments but may also modify the sequential inference process by loading and running all remaining layers. In a further example, the inference program 114 may also allow the inference model to be paused for later continuation. For example, the GPU 112 may have a processing resource that becomes restrained such that the inference is no longer allowed to run. The inference program 114 may pause processing and continue with minimized interference as the appropriate data has been saved in the corresponding allocations 305, 310, 315 of the available GPU memory and the intermediate information allows for the sequential inference process to continue without requiring significant re-calculations or re-processing to resume.

To further illustrate the operations of the inference program 114, reference is now made to an illustrative exemplary embodiment. According to the illustrative exemplary embodiment, the inference model may include a determined number of total layers N. FIG. 4 depicts an exemplary full inference 400, in accordance with the exemplary embodiments. As illustrated, the full inference 400 is directed to an inference model that includes five total layers (i.e., N is five). The five total layers includes a layer0 405, a layer1 410, a layer2 415, a layer3 420, and a layer4 425. The layer0 405 may be an input layer where the input from the user is processed. The layer4 425 may be an output layer where the output is a prediction that is generated for the input based on the inference that is performed. The layer1 410, the layer2 415, and the layer3 420 may be intermediate, “hidden” layers of the inference model. As one skilled in the art will understand, the nodes of each layer 405-425 may be interconnected with the nodes of the previous layer (if available) and a subsequent layer (if available). Specifically, each of the nodes of one layer may be connected to each of the nodes of an adjacent layer (e.g., prior layer and subsequent layer).

FIG. 5 depicts an exemplary series of sequences 500, 525, 550 for the full inference 400 of FIG. 4, in accordance with the exemplary embodiments. Continuing with the illustrative exemplary embodiment, the inference program 114 may perform the sequential inference process for the full inference 400. As illustrated in the series of sequences 500, 525, 550, the inference program 114 may have determined that the count M for the N=5 layers is set to 3. That is, the inference program 114 may load 3 layers at a time for each step of the sequential inference process. For example, the sequence 500 may be a first step of the sequential inference process. Accordingly, the inference program 114 may load the layer0 405, the layer1 410, and the layer2 415 in the layers allocation 305. The inference program 114 may store the input corresponding to the layer0 405 in the input/output allocation 310 (e.g., corresponding to the step input for the first step of the sequential inference process). The inference program 114 may run these layers until a step output from the layer2 415 is generated and stored in the input/output allocation 310. The inference program 114 may generate intermediate information for the first step of the sequential inference process that indicates a location of the step output of this first step in the input/output allocation 310. The inference program 114 may store the intermediate information in the intermediate information allocation 315.

Once the inference program 114 has completed the first step of the sequential inference process (e.g., the output of the layer2 415 is generated), the inference program 114 may release one or more layers and load a corresponding number of further layers. As illustrated in FIG. 5, the inference program 114 may release and load layers one at a time for each step of the sequential inference process. Furthermore, the inference program 114 may release the lowest level layer and load the next higher level layer. Thus, as shown in the sequence 525, the inference program 114 may release the layer0 405 and load the layer3 420. The layer1 410 and the layer2 415 may remain among the M layers that are loaded. In this way, the layer1 410 and the layer2 415 are calculated parallelly. The sequence 525 being the second step of the sequential inference process may therefore load the layer1 410, the layer2 415, and the layer3 420 in the layers allocation 305. The inference program 114 may overwrite the data of the previous M layers with the current M layers. The inference program 114 may specifically overwrite the data of the layer0 405 with the data of the layer3 420 (e.g., to save overwriting time associated with the remaining layers). The inference program 114 may store the step input corresponding to the output of the layer2 415 in the input/output allocation 310. The inference program 114 may run these layers until a step output from the layer3 420 is generated and stored in the input/output allocation 310. The inference program 114 may generate intermediate information for the second step of the sequential inference process that indicates a location of the step output of this second step in the input/output allocation 310. The inference program 114 may store the intermediate information in the intermediate information allocation 315.

Once the inference program 114 has completed the second step of the sequential inference process (e.g., the output of the layer3 420 is generated), the inference program 114 may release the lowest level layer and load the next higher level layer. Thus, as shown in the sequence 550, the inference program 114 may release the layer1 410 and load the layer4 425. The layer2 415 and the layer3 420 may remain among the M layers that are loaded. In this way, the layer2 415 and the layer3 420 are calculated parallelly. The sequence 550 being the third and last step of the sequential inference process may therefore load the layer2 415, the layer3 420, and the layer4 425 in the layers allocation 305. The inference program 114 may store the step input corresponding to the output of the layer3 420 in the input/output allocation 310. The inference program 114 may run these layers until a step output from the layer4 425 is generated and stored in the input/output allocation 310. With no further layers, the inference program 114 may forgo generating intermediate information. The step output of the layer4 425 may be the output for the inference model corresponding to the prediction for the input.

The exemplary embodiments are configured to run an inference model on a restrained GPU where the GPU has a restrained memory resource. The restrained memory resource may prevent the entire inference model to be loaded and run. Accordingly, the exemplary embodiments may perform a sequential inference process in which the layers of the inference model are processed using a subset of the layers. The exemplary embodiments may release a layer in the subset and load a new layer into the subset with remaining layers in the subset being calculated parallelly. The exemplary embodiments may generate and utilize intermediate information such that a location of an output from a previous subset of the layers is known in the GPU memory. This process may continue until the exemplary embodiments have processed all the layers of the inference model and the output from the last layer is the prediction for the input entered for the first layer of the inference model.

FIG. 6 depicts a block diagram of devices within the model prediction system 100 of FIG. 1, in accordance with the exemplary embodiments. It should be appreciated that FIG. 6 provides only an illustration of one implementation and does not imply any limitations with regard to the environments in which different embodiments may be implemented. Many modifications to the depicted environment may be made.

Devices used herein may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11 are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Devices used herein may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Devices used herein may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Devices used herein may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, RAY drive or interface 14 and network adapter or interface 16 may comprise hardware and software (stored on computer readable storage media 08 and/or ROM 06).

The programs described herein are identified based upon the application for which they are implemented in a specific one of the exemplary embodiments. However, it should be appreciated that any particular program nomenclature herein is used merely for convenience, and thus the exemplary embodiments should not be limited to use solely in any specific application identified and/or implied by such nomenclature.

Based on the foregoing, a computer system, method, and computer program product have been disclosed. However, numerous modifications and substitutions can be made without deviating from the scope of the exemplary embodiments. Therefore, the exemplary embodiments have been disclosed by way of example and not limitation.

It is to be understood that although this disclosure includes a detailed description on cloud computing, implementation of the teachings recited herein are not limited to a cloud computing environment. Rather, the exemplary embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 7, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 40 and cloud computing environment 50 can communicate with any type of computerized device over any type of network and/or network addressable connection (e.g., using a web browser).

Referring now to FIG. 8, a set of functional abstraction layers provided by cloud computing environment 50 (FIG. 7) is shown. It should be understood in advance that the components, layers, and functions shown in FIG. 8 are intended to be illustrative only and the exemplary embodiments are not limited thereto. As depicted, the following layers and corresponding functions are provided:

Hardware and software layer 60 include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and inference model processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for running an inference model with a graphical processing unit (GPU) having a restrained resource, the method comprising:
receiving an input for which the inference model is run using a sequential inference process comprising a plurality of steps, the inference model comprising a plurality of layers including a first layer representing the input, a last layer representing an output for the input as generated by running the inference model, and at least one intermediate layer between the first layer and the last layer;
determining information associated with the inference model including an input size for each of the layers, an output size for each of the layers, and an available GPU memory on which the inference model is to run, the available GPU memory being the restrained resource;
determining a count (M) of the layers based on the information associated with the inference model, the count being a value less than a total number of the layers of the inference model, each of the steps of the sequential inference process loading and running M layers of the layers of the inference model;
determining allocations in the available GPU memory for each of the steps of the sequential inference process, the allocations configured for data associated with the M layers, a step input and a step output, and intermediate information, the step input being input data for one of the steps, the step output being output data for the one of the steps, and the intermediate information being memory identification information for the step output;
loading and running the M layers using the step input to calculate the step output; and
generating the intermediate information for the step output for a subsequent step to utilize the step output as a further step input in the subsequent step.

2. The computer-implemented method of claim 1, wherein, as a result of calculating the step output for the M layers, the method further comprises:
releasing one of the M layers; and
further loading and further running a further one of the layers of the inference model to create further M layers for the subsequent step.

3. The computer-implemented method of claim 2, wherein the released one of the M layers is a lowest level layer among the M layers and the loaded one of the further M layers is a next higher level layer relative to the M layers.

4. The computer-implemented method of claim 2, further comprising:
repeating the loading and running step, the generating step, the releasing step, and the further loading and further running step until the further M layers includes a last layer of the layers of the inference model.

5. The computer-implemented method of claim 1, wherein the memory identification information indicates a location within the allocations where the step output is stored.

6. The computer-implemented method of claim 1, wherein the step input for a first step of the sequential inference process corresponds to the input and the step output for a last step of the sequential inference process corresponds to the output.

7. The computer-implemented method of claim 1, wherein the step output is retained in the allocations until a last layer of the layers of the inference model is processed.

8. A non-transitory computer-readable storage media that configures a computer to perform program instructions stored on the non-transitory computer-readable storage media for running an inference model with a graphical processing unit (GPU) having a restrained resource, the program instructions comprising:
receiving an input for which the inference model is run using a sequential inference process comprising a plurality of steps, the inference model comprising a plurality of layers including a first layer representing the input, a last layer representing an output for the input as generated by running the inference model, and at least one intermediate layer between the first layer and the last layer;
determining information associated with the inference model including an input size for each of the layers, an output size for each of the layers, and an available GPU memory on which the inference model is to run, the available GPU memory being the restrained resource;
determining a count (M) of the layers based on the information associated with the inference model, the count being a value less than a total number of the layers of the inference model, each of the steps of the sequential inference process loading and running M layers of the layers of the inference model;
determining allocations in the available GPU memory for each of the steps of the sequential inference process, the allocations configured for data associated with the M layers, a step input and a step output, and intermediate information, the step input being input data for one of the steps, the step output being output data for the one of the steps, and the intermediate information being memory identification information for the step output;
loading and running the M layers using the step input to calculate the step output; and
generating the intermediate information for the step output for a subsequent step to utilize the step output as a further step input in the subsequent step.

9. The computer program product of claim 8, wherein, as a result of calculating the step output for the M layers, the program instructions further comprise:
releasing one of the M layers; and
further loading and further running a further one of the layers of the inference model to create further M layers for the subsequent step.

10. The computer program product of claim 9, wherein the released one of the M layers is a lowest level layer among the M layers and the loaded one of the further M layers is a next higher level layer relative to the M layers.

11. The computer program product of claim 9, wherein the program instructions further comprise:
repeating the loading and running step, the generating step, the releasing step, and the further loading and further running step until the further M layers includes a last layer of the layers of the inference model.

12. The computer program product of claim 8, wherein the memory identification information indicates a location within the allocations where the step output is stored.

13. The computer program product of claim 8, wherein the step input for a first step of the sequential inference process corresponds to the input and the step output for a last step of the sequential inference process corresponds to the output.

14. The computer program product of claim 8, wherein the step output is retained in the allocations until a last layer of the layers of the inference model is processed.

15. A computer system for running an inference model with a graphical processing unit (GPU) having a restrained resource, the computer system comprising:
one or more computer processors, one or more computer-readable storage media, and program instructions stored on the one or more of the computer-readable storage media for execution by at least one of the one or more processors capable of performing a method, the method comprising:
receiving an input for which the inference model is run using a sequential inference process comprising a plurality of steps, the inference model comprising a plurality of layers including a first layer representing the input, a last layer representing an output for the input as generated by running the inference model, and at least one intermediate layer between the first layer and the last layer;
determining information associated with the inference model including an input size for each of the layers, an output size for each of the layers, and an available GPU memory on which the inference model is to run, the available GPU memory being the restrained resource;
determining a count (M) of the layers based on the information associated with the inference model, the count being a value less than a total number of the layers of the inference model, each of the steps of the sequential inference process loading and running M layers of the layers of the inference model;
determining allocations in the available GPU memory for each of the steps of the sequential inference process, the allocations configured for data associated with the M layers, a step input and a step output, and intermediate information, the step input being input data for one of the steps, the step output being output data for the one of the steps, and the intermediate information being memory identification information for the step output;
loading and running the M layers using the step input to calculate the step output; and
generating the intermediate information for the step output for a subsequent step to utilize the step output as a further step input in the subsequent step.

16. The computer system of claim 15, wherein, as a result of calculating the step output for the M layers, the method further comprises:
releasing one of the M layers; and
further loading and further running a further one of the layers of the inference model to create further M layers for the subsequent step.

17. The computer system of claim 16, wherein the released one of the M layers is a lowest level layer among the M layers and the loaded one of the further M layers is a next higher level layer relative to the M layers.

18. The computer system of claim 15, wherein the method further comprises:
repeating the loading and running step, the generating step, the releasing step, and the further loading and further running step until the further M layers includes a last layer of the layers of the inference model.

19. The computer system of claim 15, wherein the memory identification information indicates a location within the allocations where the step output is stored.

20. The computer system of claim 15, wherein the step input for a first step of the sequential inference process corresponds to the input and the step output for a last step of the sequential inference process corresponds to the output.
